(19) United States
(12) Patent Application Publication
(10) Pub. No.: US 2008/0297490 A1
(43) Pub. Date: Dec. 4, 2008

(54) Stylus for a touch-screen device

(76) Inventor: Gordon K. Adkins, Apalachicola, FL (US)

Correspondence Address: J. WILEY HORTON, ESQUIRE;Pennington, Moore, Wilkinson, Bell & Dunbar, P.A., Post Office Box 10095, Tallahassee, FL, 32302-2095, US

(21) Appl. No.: 11/807,417

(22) Filed: May 29, 2007

(51) Int. Cl. G06F 3/033

(52) U.S. Cl. 345/179

(57) ABSTRACT

A stylus for use in operating any small device requiring small buttons or touch-screen commands. The stylus is comprised of a wrap, and stylus tip. The wrap encircles and engages a user's digit. The tip of the stylus extends downward from the central axis of the user's digit to be used to connect with the screen or buttons on a hand-held device.

### BACKGROUND OF THE INVENTION

1. Field of the Invention

This invention relates to the field of devices made for operation of touch responsive user interfaces. More specifically, the invention comprises a stylus modified for attachment to a user's thumb or finger so as to operate a device using a touch-screen or small buttons.

2. Description of the Related Art

Personal Digital Assistants (PDA's) including electronic organizers, palmtops, and other hand-held devices are in wide use today. PDA's typically have a touch-screen and small buttons allowing data entry and selections. Generally a user would operate the touch-screen and small buttons with the provided stylus (in the shape of a small pen) or the user's finger itself.

A small pen-shaped stylus is utilized in much the same way as a pen is used. The stylus allows the user to make contact with the touch-screen commands or small buttons. However, the small size of the stylus and screen makes these operations awkward. Additionally, the user must hold the device in one hand and operate the stylus with the other hand, leaving no hand free. Using a fingertip in place of the stylus is also difficult, as the tip of a finger is broad compared to the small touch-screen command buttons. Using a stylus instead of a finger is preferable, since the transfer of natural oils from a user's finger onto the touch-screen shortens the life of the touch-screen.

A stylus allowing one-handed operation of a touch-screen device would be desirable. The present invention achieves this objective, as well as others that are explained in the following description.

### BRIEF SUMMARY OF THE INVENTION

The present invention comprises a stylus for use in the operation of any small device requiring the actuation of small buttons or the entry of touch-screen commands. The stylus is comprised of a wrap and an attached stylus tip. The wrap encircles a user's digit thereby attaching the stylus to the digit. The tip of the stylus extends downward from the central axis of the user's digit so that it may be conveniently used to make contact with the screen or buttons on a hand-held device.

In the preferred embodiment, a tongue extends away from the wrap of the stylus, from which the tip descends downward. The stylus is preferably made from a material which is pliable and which frictionally engages the user's digit to provide a secure attachment to the user's digit.

By allowing for the stylus to attach to the user's thumb with the tip extending downward away from the central axis of the user's thumb, the user can operate the electronic device using only one hand.

### BRIEF DESCRIPTION OF THE SEVERAL VIEWS OF THE DRAWINGS

FIG. 1 is a perspective view, showing the present invention in relation to a user's thumb.

FIG. 2 is a perspective view, showing the present invention being used on a hand-held device with one hand.

FIG. 3 is a perspective view, showing the preferred embodiment of the present invention.

FIG. 4 is a perspective view, showing the present invention attached to a hand-held device by way of a lanyard.

FIG. 5 is a perspective view, showing a means of attaching the present invention to a hand-held device by way of a small magnet.

FIG. 6 is a perspective view, showing alternative embodiments for the position of the tip of the stylus.

FIG. 7 is a side view, showing several possible embodiments of the invention with different angles of the tip of the stylus in relation to the tongue and central axis of the thumb.

FIG. 8 is a perspective view, showing an alternative embodiment of the present invention.

FIG. 9 is a perspective view, showing an alternative embodiment of the present invention with multiple tips.

FIG. 10 is a perspective view, showing the user's thumb rotation as it moves across touch-screen of hand-held device.

FIG. 11 is a perspective view, showing an alternative embodiment of the present invention with multiple tips.

FIG. 12 is a perspective view, showing an alternative embodiment of the present invention with a concave cup at the narrow end of tip.

FIG. 13 is a perspective view, showing a concave cup at the end of a stylus pen.

FIG. 14 is a perspective view, showing an alternative embodiment of the present invention with an angular tip.

FIG. 15 is a perspective view, showing the user operating a touch-screen device with two digits and two styluses.

### REFERENCE NUMERALS IN THE DRAWINGS

| | | | |
|---|---|---|---|
| 10 | tip | 12 | tongue |
| 14 | wrap | 16 | lanyard hole |
| 18 | digit | 20 | hand-held device |
| 22 | lanyard | 24 | touch-screen |
| 26 | central axis | 28 | angle of descent |
| 30 | crossbar | 32 | stylus |
| 34 | magnet | 36 | hand |
| 38 | hook | 40 | concave cup |
| 42 | pen | | |

### DETAILED DESCRIPTION OF THE INVENTION

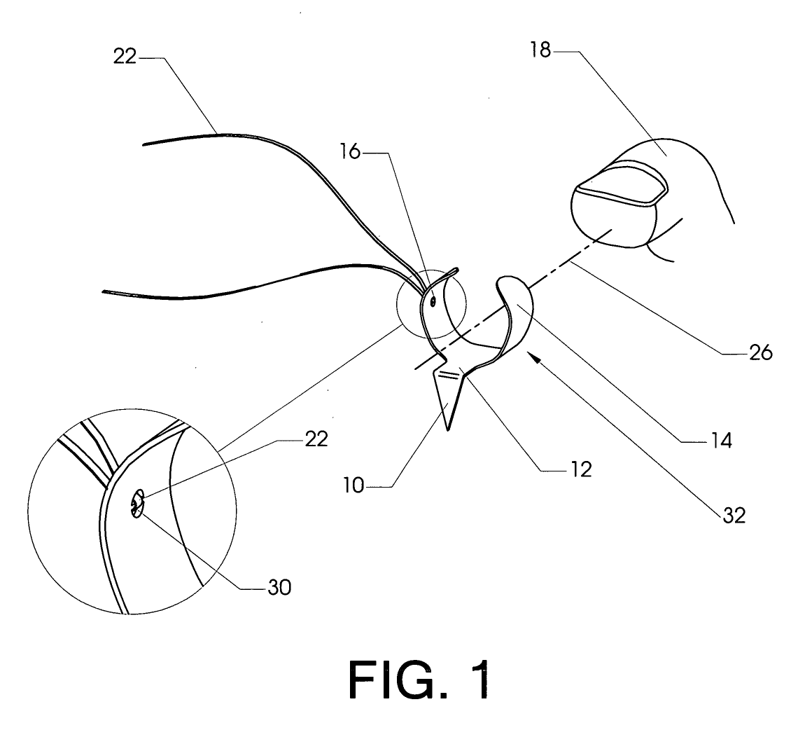

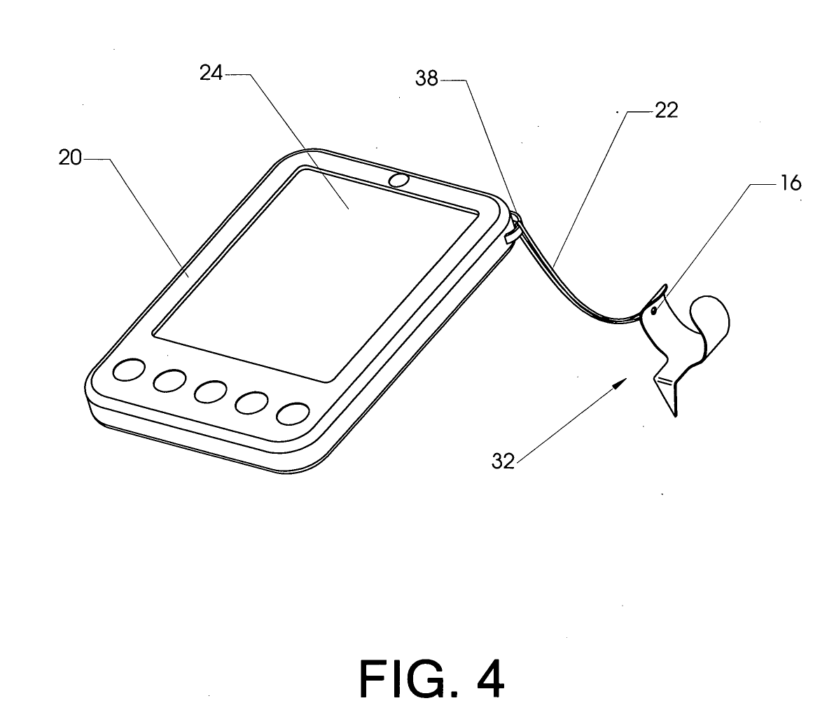

FIG. 1 shows the present invention in position to be installed on a user's digit 18 (preferably a thumb but possibly a finger). This view shows digit 18 of the user aligned with stylus 32. Wrap 14 is configured to encircle a user's digit 18 along central axis 26. “Digit” for purposes of this invention is defined as any finger or thumb on either hand of the user. Digit 18 of the user slides or fits into wrap 14. Wrap 14 can be made of any material. Wrap encircles digit 18 and allows the user to adjust the grip of wrap 14. For example, wrap 14 can be made up of plastic which frictionally engages digit 18 or of a deformable material which the user presses inward to clamp to digit 18, such as certain metals. Wrap 14 preferably contains a lanyard hole 16 through which a lanyard 22 can be threaded. In one embodiment of the present invention lanyard hole 16 contains a crossbar 30 around which lanyard 22 is threaded. As the reader will observe in FIG. 4, lanyard 22 can be attached to hook 38 located on hand-held device 20 to prevent the user from losing or dropping the small stylus 32. Returning to FIG. 1, tongue 12 of stylus 32 extends outward from wrap 16 in a direction approximately parallel to central axis 26 of the digit 18. Tip 10 attaches to any point on tongue 12. Tip 10 extends downward from central axis 26 of digit 18. In the preferred embodiment of the invention, tip 10 is made of a soft material such as rubber or plastic, so as to prevent stylus 32 from scratching touch-screen 24. The narrow end of tip 10 can be either concave or convex.

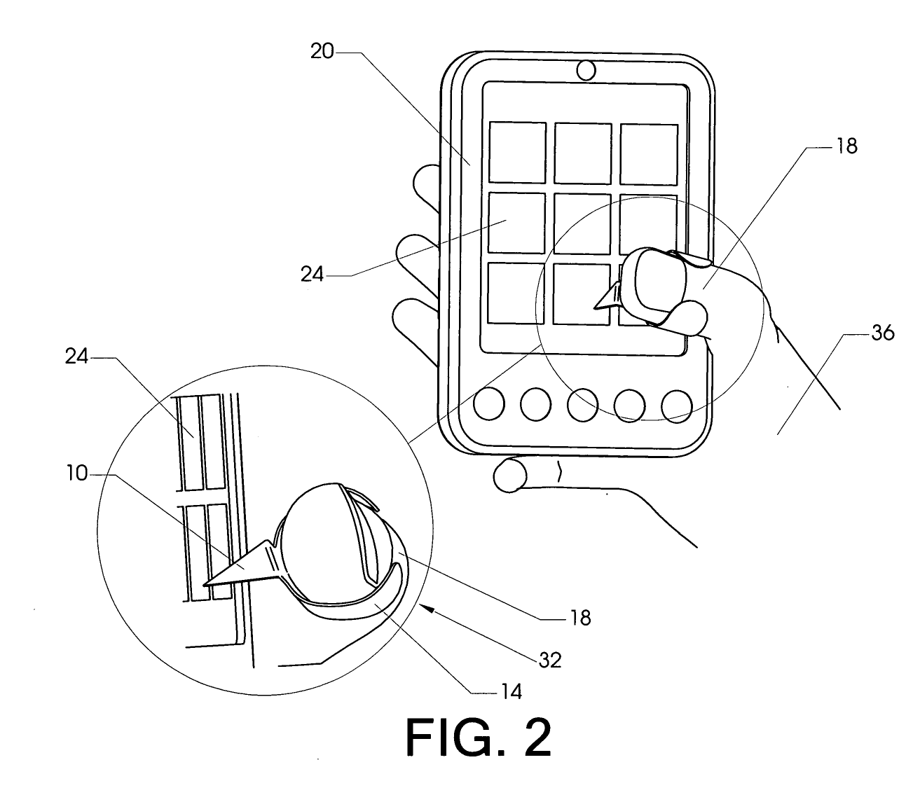

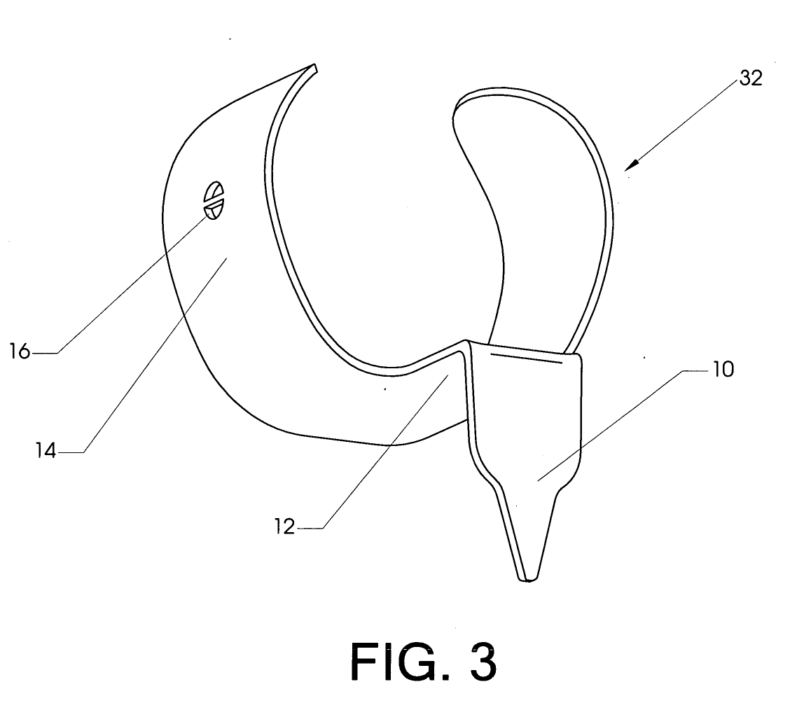

The illustration in FIG. 2 portrays how the hand-held device 20 is fully operative with only one hand 36 when utilizing stylus 32. Hand 36 cradles hand-held device 20 while digit 18, preferably the user's thumb, operates touch-screen 24. As shown in the exploded view of FIG. 2, stylus 32 is secured to digit 18 by wrap 14. The user can freely move digit 18 and stylus 32 around touch-screen 24. Because tip 10 descends downward with respect to central axis of digit 18, the user can comfortably operate touch-screen 24 without awkwardly bending digit 18 to make contact with touch-screen 24. By eliminating the need to hold digit 18 in a constant bent position, the invention allows the user to operate hand-held device 20 comfortably for extended periods of time. FIG. 3 illustrates the preferred embodiment of the present invention. This view of stylus 32 better illustrates the descent of tip 10 away from tongue 12 of stylus 32.

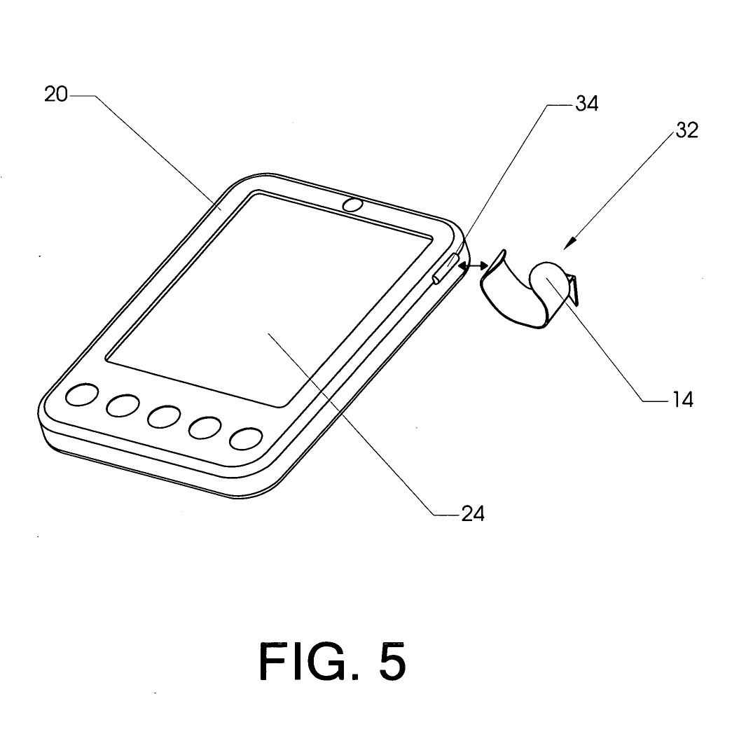

As the reader will observe in FIG. 4 and FIG. 5 there can be several different ways of attaching stylus 32 to hand-held device 20. In FIG. 4 lanyard 22 attaches stylus 32 to hook 38 on hand-held device 20. FIG. 5, on the other hand, illustrates stylus 32 lining up with magnet 34. Magnet 34 is located on the side of hand-held device 20 and is preferably a neodymium magnet which attracts stylus 32. Stylus 32 is either made of a material which inherently engages magnet 34 or a strip of material which engages magnet is permanently attached to stylus 32.

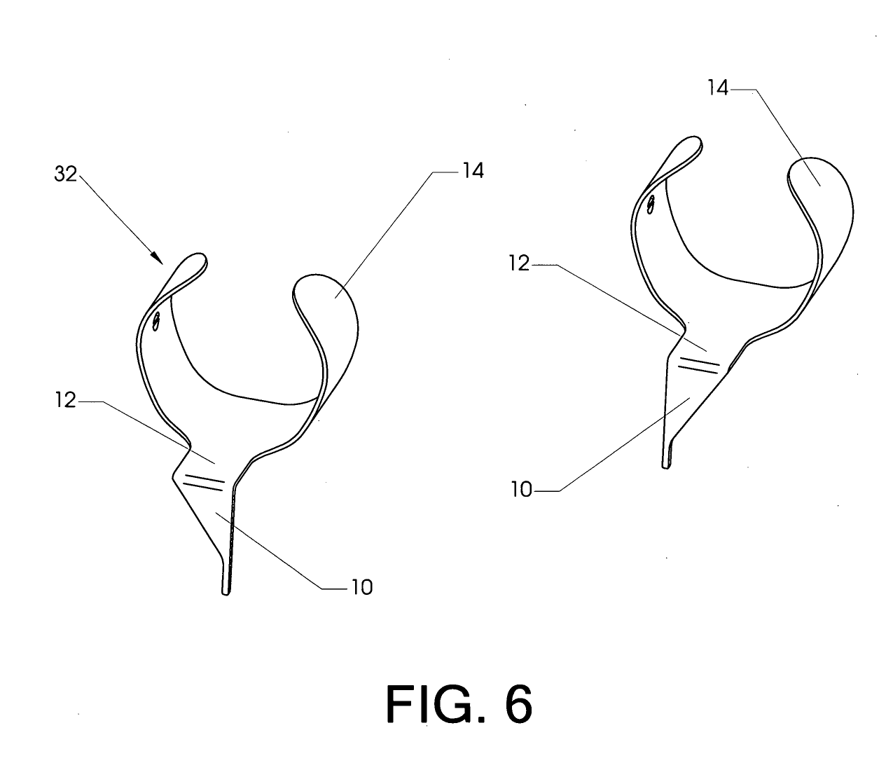

FIG. 6 illustrates an alternative embodiment of the present invention where tip 10 of stylus 32 is offset to the right or the left of tongue 12. As the position of tip 10 changes, the pressure on touch-screen 24 may vary according to how each particular user aligns digit 18 with hand-held device 20. The different available positions of tip 10 allow each individual user to choose a stylus incorporating the most comfortable tip position according to each user's preference.

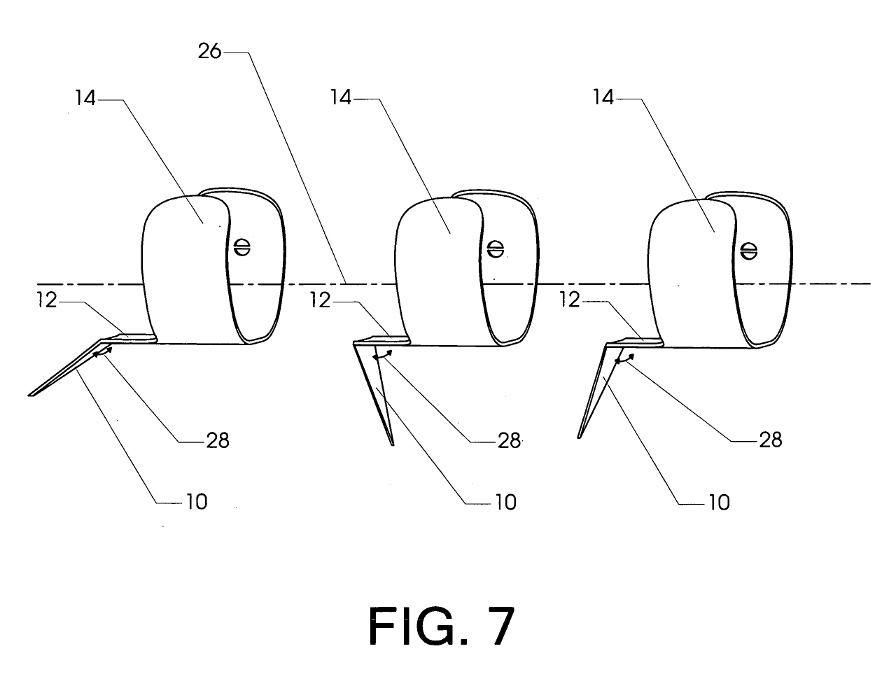

FIG. 7 shows a side view of three different embodiments of the present invention. Each embodiment includes a different angle of descent 28. Angle of descent 28 is created by the intersection between the plane of tip 10 and the plane of tongue 12, which is also approximately parallel to the base of wrap 14 and central axis 26. As the reader will observe, angle of descent 28 can be acute, obtuse or 90 degrees. Similar to the choice of tip position, the user would be able to choose the most comfortable angle of descent 28 dependent on the user's personal preference.

As FIG. 6 and FIG. 7 show, the orientation of tip 10 to tongue 12 and base of wrap 14 can be significantly varied. However, in each variation tip 10 descends downward from the central axis of the user's digit. This ensures that the user, using only one hand, can easily interact with touch-screen 24.

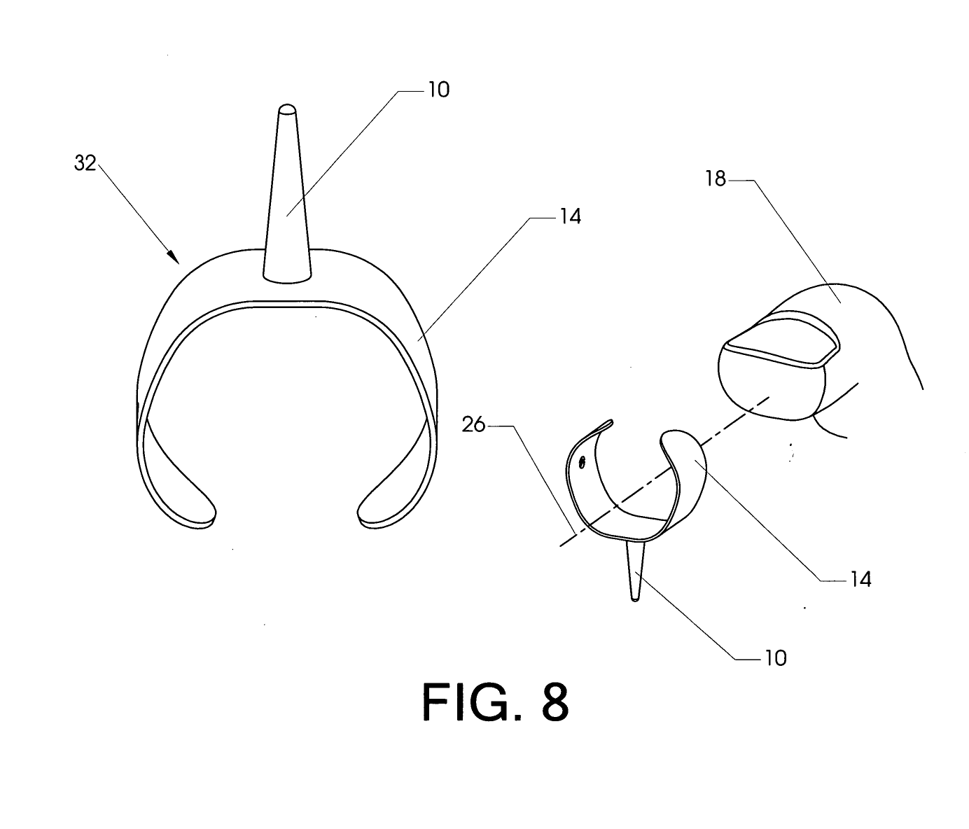

FIG. 8 illustrates still another alternative embodiment of the present invention in which tip 10 extends directly from the base of wrap 14. The narrow end of tip 10 ends in a convex cup which is used to communicate with hand-held device 20. The reader will observe that tip 10 still descends downward away from central axis 26 of the user's digit 18, though the tongue has been omitted. The use of the device is essentially the same.

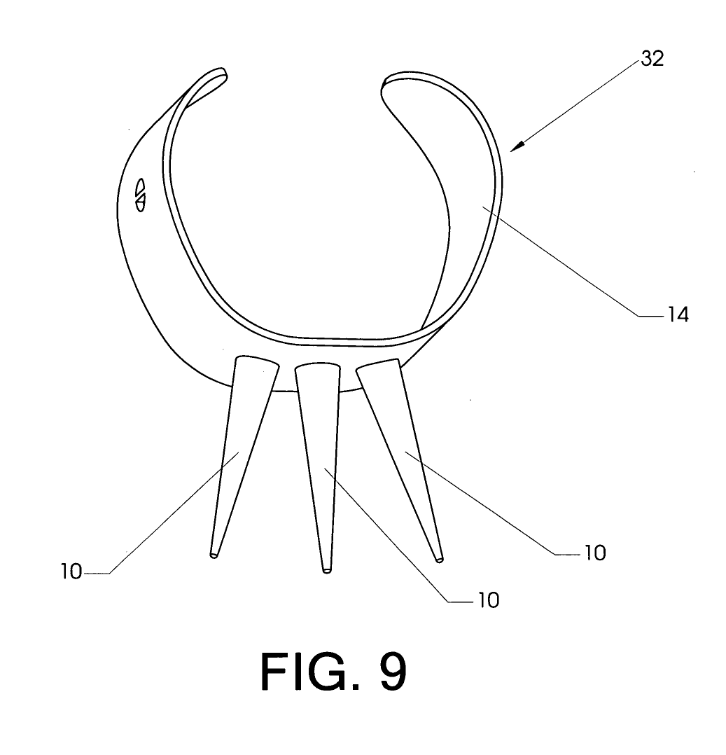

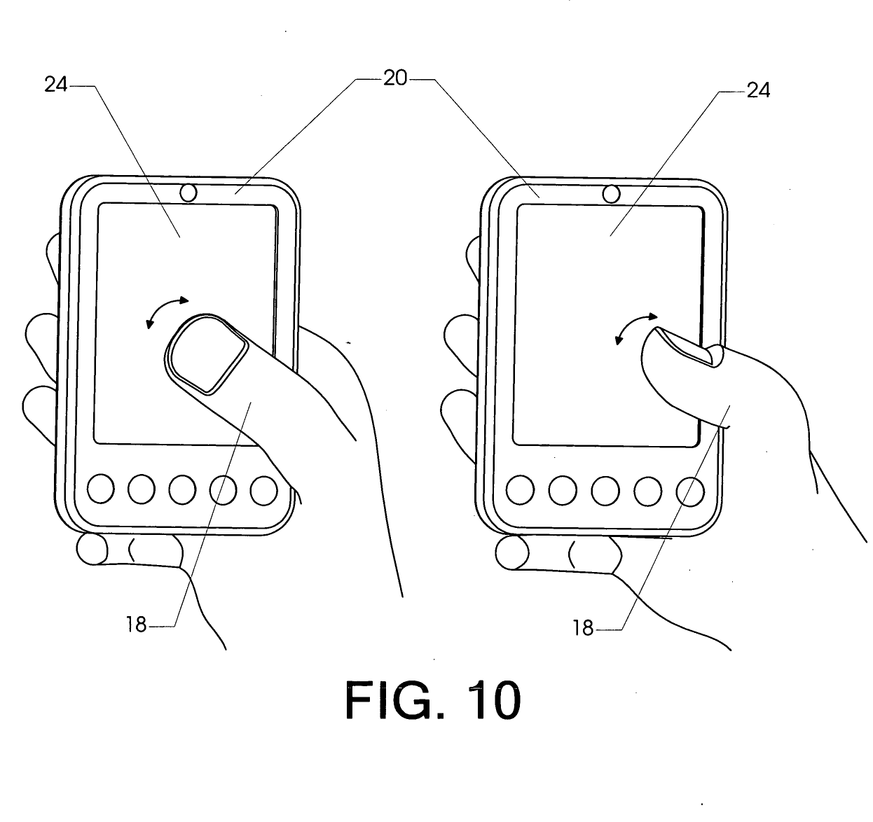

FIG. 9 illustrates another alternative embodiment of the present invention which has more than one tip 10 descending downward away from central axis 26 of the user's digit 18. By having a second or third tip 10 protruding from wrap 14, the user will be able to operate hand-held device 20 with greater ease and comfort since the thumb rotates while moving across touch-screen 24. This natural rotation of the user's thumb as it moves across the touch-screen is illustrated in FIG. 10. As the user's digit 18 rotates the middle tip 10 may no longer provide the best point at which to contact touch-screen 24.

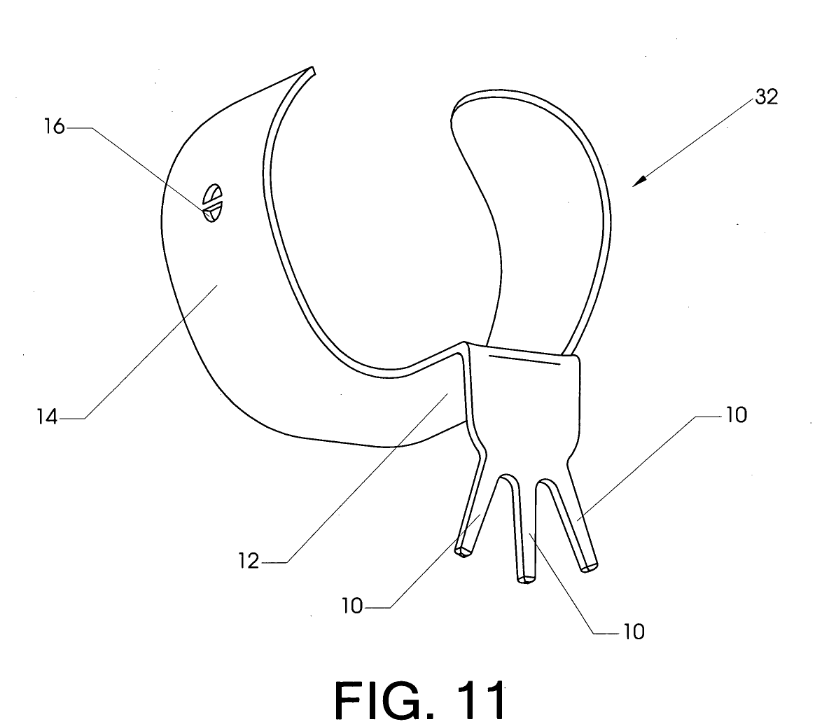

FIG. 10 exemplifies the rotation of the user's thumb. As digit 18 moves across touch-screen 24 digit 18 rotates in relation to touch-screen 24. By having an additional tip offset to the right of user's thumb as seen in FIG. 9 and FIG. 11 user can contact touch-screen 24 with the additional tip 10 without having to overcompensate to continue to use the middle tip 10. Alternatively, a left-handed individual would benefit from an additional tip offset to the left of user's left thumb. The additional tip 10 will reduce the amount of movement required to operate hand-held device 20. The reduction in overall movement, particularly the bending motion, will also reduce the fatigue which can occur during the operation of hand-held device 20.

FIG. 11 shows another alternative embodiment of the present invention which has more than one tip 10 descending downward away from central axis 26 of the user's digit 18 attached to tongue 12 of stylus 34.

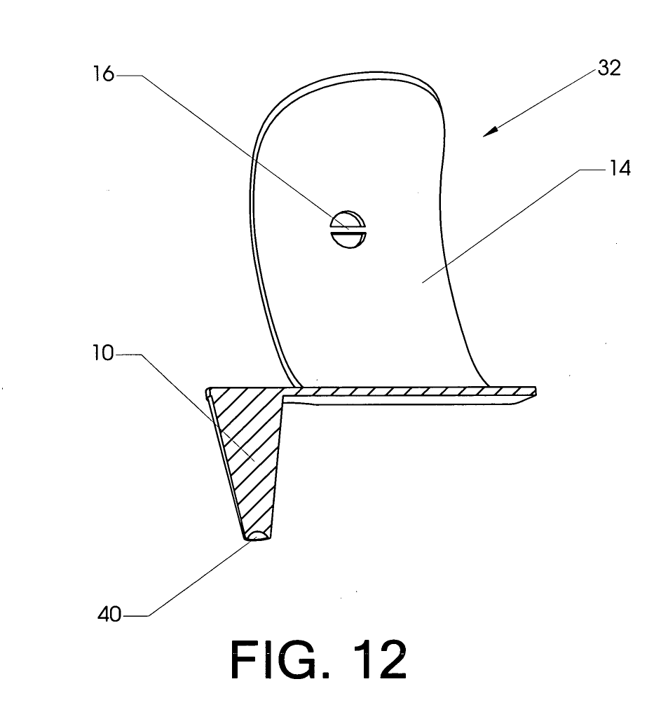

FIG. 12 illustrates an alternative embodiment of the present invention where concave cup 40 is positioned at the narrow end of tip 10. Concave cup 40 allows the user to more easily engage a domed structure located on hand-held device 20. In one embodiment the surface area of concave cup 40 would be made up of a rubber material to increase the gripping ability of stylus 32. Concave cup 40 could be applied to any stylus tip.

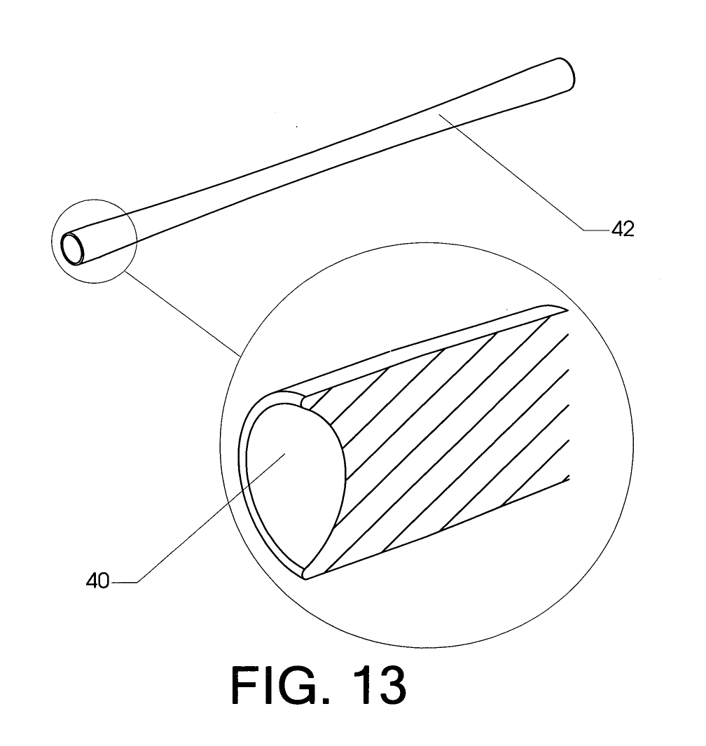

FIG. 13 shows concave cup 40 located at the end of a stylus pen 42. Concave cup 40 allows the user to more easily rotate a domed structure as the user moves pen 42.

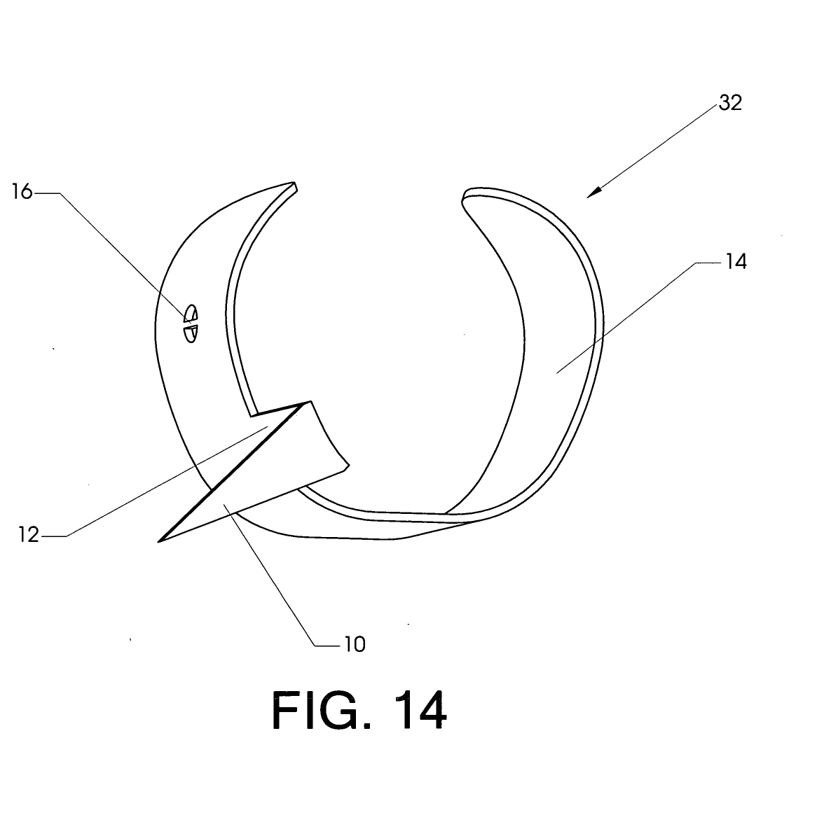

FIG. 14 illustrates an alternative embodiment of the present invention in which tip 10 extends outward approximately perpendicular to central axis of the digit. In this embodiment tongue 12 and tip 10 are offset to the right or left of wrap 14. A user may be more comfortable utilizing tip 10 in this position due to the natural alignment of digit 18 with hand-held device 20. Tip 10 can also extend directly from wrap 14 eliminating the need for tongue 12.

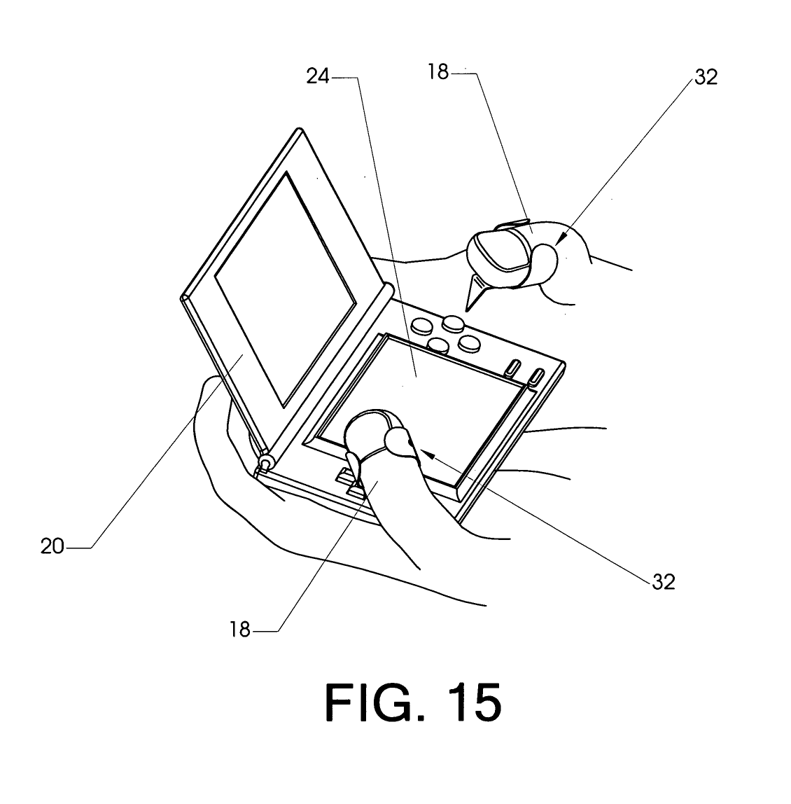

FIG. 15 illustrates a user operating hand-held device 20 which utilizes two digits 18, such as a NINTENDO™. The use of stylus 32 in this manner allows user to quicker and better access to touch-screen 24 with both the left and right digit 18. This can result in enhanced game play for the user.

The preceding description contains significant detail regarding the novel aspects of the present invention. It should not be construed, however, as limiting the scope of the invention but rather as providing illustrations of the preferred embodiments of the invention. As an example, wrap 14 could be attached around digit 18 by way of a Velcro overlapping fabric situated around wrap 14. Additionally, tip 10 could be made in different lengths and thicknesses to correspond with different contact points on different types of touch-screen devices. Thus, the scope of the invention should be fixed by the following claims, rather than by the examples given.

Having described my invention, I claim:

1. A stylus allowing a user to operate a hand-held device having user-interface features responsive to physical contact, said user having a digit with a central axis, comprising:
a. a wrap configured to at least partially encircle said digit and frictionally engage said digit, said wrap having a central axis which is approximately aligned with said central axis of said digit when said wrap is installed on said digit; and
b. at least one tip connected to said wrap, said at least one tip having a wide end and a narrow end, said at least one tip extending away from said wrap in a direction which is approximately perpendicular to said central axis of said wrap.

2. A stylus as recited in claim 1, wherein said connection between said at least one tip and said wrap comprises a tongue extending away from said wrap in a direction which is approximately parallel to said central axis of said wrap.

3. The stylus of claim 1, wherein said wrap includes a lanyard hole for attachment to a lanyard.

4. The stylus of claim 3, wherein said hand-held device further comprises a hook configured to be attached to said lanyard.

5. The stylus of claim 1, wherein said hand-held device further comprises a magnet configured to detachably connect said stylus to said hand-held device.

6. The stylus of claim 2, wherein said at least one tip is laterally offset from said tongue.

7. The stylus of claim 1, wherein said at least one tip extends downward from said central axis of said digit at an acute angle.

8. The stylus of claim 1, wherein said at least one tip extends downward from said central axis of said digit at an obtuse angle.

9. The stylus of claim 1, wherein said narrow end of said at least one tip further comprises a convex cup.

10. The stylus of claim 1, wherein said narrow end of said at least one tip further comprises a concave cup.

11. A stylus allowing a user to operate a hand-held device with one hand, having user-interface features responsive to physical contact, said user having a thumb with a central axis, comprising:
a. a wrap configured to at least partially encircle said thumb and frictionally engage said thumb, said wrap having a central axis which is approximately aligned with said central axis of said thumb when said wrap is installed on said thumb; and
b. a plurality of tips connected to said wrap, said plurality of tips having a wide end and a narrow end, said plurality of tips extending away from said wrap in a direction which is approximately perpendicular to said central axis of said wrap.

12. A stylus as recited in claim 11, wherein said connection between said plurality of tips and said wrap comprises a tongue extending away from said wrap in a direction which is approximately parallel to said central axis of said wrap.

13. The stylus of claim 11, wherein said wrap includes a lanyard hole for attachment to a lanyard.

14. The stylus of claim 13, wherein said hand-held device further comprises a hook configured to be attached to said lanyard.

15. The stylus of claim 11, wherein said hand-held device further comprises a magnet configured to detachably connect said stylus to said hand-held device.

16. The stylus of claim 11, wherein said plurality of tips are laterally offset from said tongue.

17. The stylus of claim 11, wherein said plurality of tips extend downward from said central axis of said thumb at an acute angle.

18. The stylus of claim 11, wherein said plurality of tips extend downward from said central axis of said thumb at an obtuse angle.

19. The stylus of claim 11, wherein said narrow ends of said plurality of tips further comprises a convex cup.

20. The stylus of claim 11, wherein said narrow ends of said plurality of tips further comprises a concave cup.
